(19) United States
(12) Patent Application Publication
(10) Pub. No.: US 2026/0228437 A1
(43) Pub. Date: Aug. 6, 2026

(54) METHOD AND APPARATUS FOR CONTENT GENERATION USING PURPOSE-BASED MULTI-AGENTS BASED ON USER PERSONALIZATION DATA

(71) Applicant: ableJ Inc., Gyeonggi-do (KR)

(72) Inventors: Kyung Ho PARK, Gyeonggi-do (KR); Jong Won LEE, Seoul (KR); Mun Keun CHO, Gyeonggi-do (KR)

(21) Appl. No.: 19/252,145

(22) Filed: Jun. 27, 2025

(30) Foreign Application Priority Data
Feb. 5, 2025 (KR) 10-2025-0014504

(51) Int. Cl. G06F 40/30; G06F 16/334; G06F 40/279

(52) U.S. Cl. CPC G06F 40/30; G06F 16/3344; G06F 40/279

(57) ABSTRACT

A content generation method and apparatus using purpose-specific multi-agents based on user’s personalized data according to an embodiment collects personalized user data and stores text generated from the personalized data in a database, classifying and processing the text data according to the purpose of each agent. The embodiment includes various function-specific agents such as a resume generation agent, counseling agent, and job analysis agent, which generate content based on the personalized data in an appropriate manner. In other words, in the embodiment, each agent performs a specific function preassigned to it, and processes individual tasks assigned to each agent by sharing data through a central database.

### CROSS-REFERENCE TO RELATED APPLICATION

This application claims priority to and the benefit of Korean Patent Application No. 10-2025-0014504, filed on February 5, 2025, the disclosure of which is incorporated herein by reference in its entirety.

### BACKGROUND

### 1. Field of the Invention

The present disclosure relates to a method and apparatus for content generation using purpose-based multi-agents based on user personalization data, and more particularly, to a method and apparatus for content generation using agents that generate content based on personalization data by storing the individual records of a user in a database and enabling function-specific agents to utilize the personalization data.

### 2. Discussion of Related Art

Generative AI is an artificial intelligence technology that generates new content (text, image, audio, video, etc.) based on given data or input. Unlike traditional AI systems that merely analyze or classify existing data, generative AI produces creative outputs. However, existing generative language models often fail to fully understand the context of a text, resulting in inaccurate or unnatural outputs. For example, the model may misinterpret the user's intent and generate irrelevant content or provide overly generic responses. Moreover, when the input or training data is not optimized for individual users, the generated output may significantly deviate from the user's expectations. Additionally, biases inherent in the training data may be reflected in the results, potentially compromising fairness and accuracy. Furthermore, when generating content tailored for specific purposes (e.g., resume writing, sentiment analysis), the outputs may lack the necessary precision. For instance, a conventional language model might generate general resume phrases that do not align with a particular company's requirements.

Conventional language models also have limited capabilities in effectively processing or analyzing unstructured user data. For example, important information may not be efficiently extracted from sources such as voice data or unstructured text (e.g., diaries or recorded content). Additionally, these models often lack the ability to provide real-time suggestions for content improvement or to engage in interactive communication with users. As a result, users are typically required to manually revise the deficiencies in the generated documents.

Moreover, when dealing with complex or specialized topics, there is a risk of including incorrect information. During the processing of user data, privacy and security issues may also arise. Language models may also fail to properly understand emotions or subtle nuances contained in user text, potentially resulting in inappropriate or emotionally tone-deaf outputs. In addition, when generating long-form content or documents composed of multiple sections, traditional models often struggle to maintain logical consistency throughout. For example, the flow between paragraphs may be disjointed when using conventional language models.

### Related Art Documents

### Patent Document

Korean Registered Patent No. 10-2024-0006333 (Registered date: January 15, 2024)

Korean Registered Patent No. 10-2658219 (Registered date: April 12, 2024)

### SUMMARY OF THE INVENTION

A method and apparatus for content generation using purpose-based multi-agents based on user personalization data according to an embodiment collects user personalization data and organizes text generated from the personalization data into a database, and then processes the classified text data according to the purpose of each agent.

In addition, in the embodiment, each function-specific agent—including, for example, a self-introduction letter generation agent, a counseling agent, and a job analysis agent—generates content in an appropriate manner based on the personalization data. That is, in the embodiment, each agent performs a specific preassigned function and shares data through a central database to carry out the individual tasks assigned to each agent.

However, the problem to be solved according to one embodiment is not limited to only the matters mentioned above.

According to one embodiment of the present disclosure relates to a generation apparatus comprising a memory configured to store at least one instruction for generating contents using purpose-specific multi-agents based on user's personalized data; and a processor configured to execute the instruction, wherein the processor is configured to collect personalized data including a user’s voice; convert the collected personalized data into text using speech-to-text (STT); classify and store the converted text according to detailed information of the text; and input the classified text into at least one generative agent categorized by purpose, wherein the generative agent processes the user's personalized data and generates content corresponding to the purpose.

In one embodiment, the processor may be configured to analyze a query when the query is input by the user and select at least one generative agent to which the query is to be delivered based on a query analysis result.

In one embodiment, the processor may be configured to compare a requested function from the input query with functions performed by respective generative agents and to select at least one generative agent that performs a function similar to the requested function above a predetermined threshold level.

In one embodiment, the processor may be configured to select at least two generative agents based on the query analysis result, and the selected generative agents cooperate to generate content corresponding to a purpose of the query.

In one embodiment, the processor may be configured to evaluate relevance between the purpose of the query and a goal of each generative agent, and select a certain number of generative agents in order of highest relevance, when similarity between a requested function of the query and the functions performed by the generative agents is below a predetermined threshold level.

In one embodiment, the processor may be configured to learn a cooperation mechanism among the at least two generative agents for each generated content based on the query analysis result using an artificial intelligence model, and fine-tune the cooperation mechanism based on evaluation information indicating whether the generated content corresponds to the purpose of the query.

In one embodiment, the generative agent may include at least one of a resume generation agent, a counseling agent, and a job analysis agent.

In one embodiment, the resume generation agent may analyze text data converted from the user's personalized data to extract the user’s past experiences and career history, and generate a resume, cover letter, and application form using the extracted experiences and career history.

In one embodiment, the counseling agent may analyze text and conversation records from the user's personalized data to determine the user’s emotional state and generate questions and messages to be presented to the user based on the determined emotional state.

In one embodiment, the job analysis agent may analyze text data converted from the user's personalized data to identify the user's job aptitude information, and propose capabilities that the user needs to develop and methods for developing the capabilities based on the identified job aptitude information.

According to an embodiment, the method and apparatus for content generation using purpose-based multi-agents based on user personalization data can maximize user experience by generating content tailored to user characteristics and goals based on personalization data.

In addition, the embodiment improves efficiency and user satisfaction by providing results optimized for individual user needs, such as resume generation, counseling, and job analysis.

Further, in the embodiment, multiple agents can cooperate to perform various purposes, allowing various problems to be solved on a single platform. For example, even during resume writing, counseling messages can be provided to relieve stress by analyzing the user’s emotional state.

Furthermore, the embodiment enables integrated data management by sharing a central database, thereby reducing redundant tasks and maintaining data consistency. For example, the analysis results from the counseling agent can be used for resume writing to generate contextually natural content.

The embodiment also reduces the time and effort required for users to analyze information or create content themselves by automatically analyzing diary entries and converting them into suitable phrases that can be immediately used.

Moreover, the embodiment generates content optimized for the user’s goals (e.g., employment, counseling, career development), enabling concrete results. For instance, writing resumes tailored to the requirements of specific companies can increase the success rate of employment.

According to the embodiment, real-time response features such as emotion analysis provide immediate feedback and support to the user. In the embodiment, stress states can be detected and messages that offer psychological comfort can be immediately delivered.

In addition, as data accumulates through the embodiment, the sophistication of the AI service is enhanced, and the user’s sense of personalization and satisfaction continuously increases. As a result, content more suited to the user's preferences and goals can be provided over time.

Furthermore, in the embodiment, the emotional state of the user can be monitored through the counseling agent, and immediate assistance can be provided when necessary, thereby contributing to psychological stability. Based on the platform's flexibility and multifunctionality, it can be utilized in various fields such as education, employment, psychological counseling, and travel planning.

Moreover, the embodiment allows users to more easily achieve their goals through efficient and personalized services.

The effects obtainable from the exemplary embodiments of the present disclosure are not limited to the effects mentioned above, and other effects not mentioned may be clearly derived and understood by those of ordinary skill in the art from the following description. That is, unintended effects resulting from the implementation of the exemplary embodiments of the present disclosure may also be derived by those of ordinary skill in the art.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a content generation system using purpose-based multi-agents based on user personalization data according to an embodiment.

FIG. 2 is a diagram illustrating a configuration of a generation apparatus according to an embodiment.

FIG. 3 is a diagram illustrating types of agents stored in memory according to an embodiment.

FIG. 4 is a diagram illustrating types of agents stored in memory according to another embodiment.

### DETAILED DESCRIPTION OF EXEMPLARY EMBODIMENTS

Hereinafter, various embodiments of the present disclosure will be described with reference to the accompanying drawings. It should be understood that the various embodiments of the present disclosure may be subject to various changes and may have a variety of forms, and specific embodiments are illustrated in the drawings and detailed descriptions are provided accordingly. However, this is not intended to limit the various embodiments of the present disclosure to particular forms, and it should be understood that the present disclosure is intended to include all changes, equivalents, and substitutes falling within the spirit and scope of the present disclosure. In the description of the drawings, like reference numerals are used to refer to like elements.

In various embodiments of the present disclosure, the terms such as "comprise" or "have" are intended to specify that certain features, numbers, steps, operations, components, parts, or combinations thereof are present, but are not intended to preclude the possibility of the presence or addition of one or more other features, numbers, steps, operations, components, parts, or combinations thereof.

In various embodiments of the present disclosure, expressions such as "or" are intended to include any and all possible combinations of the listed words. For example, "A or B" may include A, B, or both A and B.

In various embodiments of the present disclosure, expressions such as "first", "second", "primary", or "secondary" may modify various components of different embodiments, but do not limit the components themselves. For example, such expressions do not limit the order and/or importance of the corresponding components, and may be used simply to distinguish one component from another.

When it is stated that a certain component is "connected" or "coupled" to another component, this may mean that the component is directly connected or coupled to the other component, but it should also be understood that other components may exist in between.

In the embodiments of the present disclosure, terms such as "module," "unit," or "part" refer to components that perform at least one function or operation, and such components may be implemented in hardware, software, or a combination of both. Furthermore, unless it is necessary for each of the multiple "modules," "units," or "parts" to be implemented as individual dedicated hardware, they may be integrated into at least one module or chip and implemented by at least one processor.

Terms that are generally defined in standard dictionaries should be interpreted as having meanings consistent with those in the context of the related art, and unless explicitly defined in various embodiments of the present disclosure, they should not be interpreted in an idealized or overly formal sense.

Hereinafter, embodiments of the present disclosure will be described in detail with reference to the accompanying drawings.

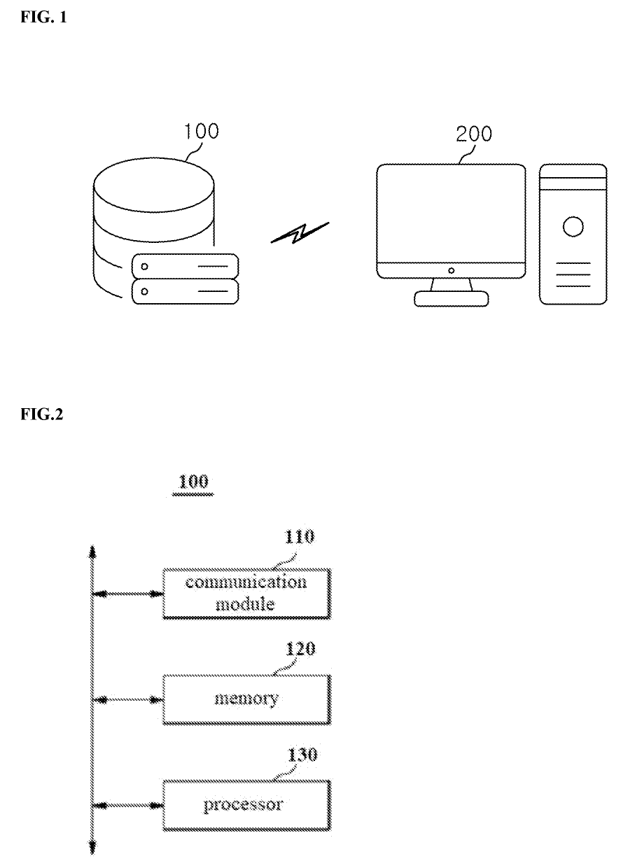

FIG. 1 is a diagram illustrating a content generation system using purpose-based multi-agents based on user personalization data according to an embodiment.

Referring to FIG. 1, the content generation system using purpose-based multi-agents based on user personalization data according to the embodiment may include a generation apparatus (100) and a user terminal (200). The generation apparatus (100) collects user personalization data from the user terminal (200) and stores it in a database. In the embodiment, the personalization data may include, but is not limited to, conversation logs between the user and an artificial intelligence, user-written diary entries, and recorded audio data. The user terminal (200) is a smart device used by the user to interact with the generation apparatus (100), and may be implemented as a computer capable of accessing a remote server or terminal via a network. The computer may include, for example, a navigation device, or a laptop or desktop computer equipped with a web browser. At least one user terminal (200) may be implemented as a device capable of accessing a remote server or terminal through a network. The user terminal (200) may be a wireless communication device ensuring portability and mobility, and may include, for example, a navigation system, PCS (Personal Communication System), GSM (Global System for Mobile communications), PDC (Personal Digital Cellular), PHS (Personal Handyphone System), PDA (Personal Digital Assistant), IMT-2000 (International Mobile Telecommunication), CDMA-2000 (Code Division Multiple Access), W-CDMA (Wideband Code Division Multiple Access), Wibro (Wireless Broadband Internet) devices, smartphones, smartpads, tablet PCs, and all types of handheld-based wireless communication devices.

In the embodiment, the generation apparatus (100) converts the personalization data collected from the user terminal (200) into text (STT, Speech-to-Text) in order to store and manage the personalization data, and stores the converted text based on detailed information of the text. The detailed information of the text in the embodiment may include, but is not limited to, the time of occurrence and the subject of the text. The generation apparatus (100) organizes the text data generated from the personalization data by time and subject and stores it in a database to allow easy user access. Thereafter, the generation apparatus (100) processes the classified text data according to the purpose of each agent. This means that each function-specific agent generates content based on the personalization data in a suitable manner. In the embodiment, the generation apparatus (100) structures the input text data in order to understand it and, if necessary, analyzes linguistic elements (sentence structure, meaning, keywords, etc.) using natural language processing (NLP) techniques. For example, it may perform removal of unnecessary phrases, keyword extraction, and syntactic analysis. In addition, it performs data filtering tailored to the purpose of the agent. In the embodiment, the generation apparatus (100) selects the necessary information based on the purpose of each agent (e.g., advertising, recommendation, personalized messaging). The generation apparatus (100) may also prioritize the text suitable for the specific agent’s purpose and evaluate its importance. Furthermore, the generation apparatus (100) may summarize the text or transform its grammatical structure to meet the intended purpose. In the embodiment, the generation apparatus (100) may perform the above processes using a combination of natural language processing techniques, machine learning models, and rule-based algorithms.

The generation apparatus (100) also operates a plurality of agents that perform specific functions. In the embodiment, each agent is a program that provides an AI (Artificial Intelligence)-based service (e.g., content generation) and may be executed by an existing general-purpose processor (e.g., CPU) or a dedicated AI processor (e.g., GPU). In the embodiment, each agent performs a specific function for content generation. The agents share data through a central database and perform their respective assigned tasks. For example, in the case of a self-introduction letter generation agent, the user’s diary entries and recorded data are converted into text (using STT technology) and systematically analyzed for past experiences and career history. Through this, key information required for employment or application writing is automatically extracted. For instance, if an experience related to “volunteer work” is recorded in the diary, the self-introduction letter generation agent converts that content into phrasing advantageous for employment. Additionally, it analyzes the user’s values (e.g., teamwork, leadership) and links them to competencies desired by companies. As a result, the self-introduction letter generation agent can write a letter reflecting the user’s desired tone (formal/informal) and the employer’s requirements. Specifically, if creativity is emphasized by a particular company, the agent extracts relevant experiences from the diary and generates customized sentences. The self-introduction letter generation agent can also suggest improvements to the drafted content or provide questions to supplement missing parts. For example, it may generate feedback such as: “You might want to add a leadership experience. Could you describe your role in a past team project?” In the embodiment, the agents may include, but are not limited to, a self-introduction letter generation agent, a counseling agent, and a job analysis agent.

FIG. 2 illustrates the configuration of a generation apparatus according to an embodiment.

In the embodiment, the generation apparatus may be implemented as a server. A server is a computing system that provides services or stores and manages data for other computers or devices over a computer network. The server accepts requests from other computers or devices, referred to as clients, and provides responses or data to those requests. The configuration of the generation apparatus (100) illustrated in FIG. 2 is merely a simplified example.

The communication module (110) may be configured regardless of the type of communication, such as wired or wireless, and may utilize various communication networks, including a Personal Area Network (PAN) and a Wide Area Network (WAN). The communication module (110) may also operate based on the World Wide Web (WWW), and may employ wireless transmission technologies used for short-range communication, such as Infrared Data Association (IrDA) or Bluetooth. For example, the communication module (110) may be responsible for transmitting and receiving data necessary for executing the techniques according to an embodiment of the present disclosure.

The memory (120) may refer to any type of storage medium. For example, the memory (120) may include at least one type of storage medium such as flash memory type, hard disk type, multimedia card micro type, card-type memory (e.g., SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, or optical disk. This memory (120) may also constitute the database shown in FIG. 1.

The memory (120) may store at least one instruction that can be executed by the processor (130). In addition, the memory (120) may store any type of information generated or determined by the processor (130), as well as any type of information received from the server (200). Furthermore, the memory (120) may store various types of modules, instruction sets, or models.

The processor (130) may perform the technical features according to the embodiments of the present disclosure, as described below, by executing at least one instruction stored in the memory (120). In one embodiment, the processor (130) may include at least one core and may comprise a central processing unit (CPU), a general-purpose graphics processing unit (GPGPU), a tensor processing unit (TPU), or another processor for data analysis and/or processing.

Such a processor (130) may train a neural network or model designed using machine learning or deep learning techniques. To this end, the processor (130) may perform computations for training the neural network, including processing input data for training, extracting features from the input data, calculating errors, and updating the weights of the neural network using backpropagation. In addition, the processor (130) may perform inference under a given purpose using a model implemented by an artificial neural network method.

In an embodiment, the processor (130) collects personalization data including a user's voice and converts the collected personalization data into text (STT, Speech-to-Text). Thereafter, the processor (130) classifies and stores the converted text according to detailed information of the text.

To this end, the processor (130) collects the user's voice data in real time from the user device (e.g., smartphone, smart speaker, IoT device, etc.). This data may include user commands, conversation content, and environmental noise. In the embodiment, the collected voice data is converted into text through an STT (Speech-to-Text) engine. During the conversion process, the voice signal undergoes pre-processing to remove noise and extract voice features. In this process, the user's pronunciation, intonation, and speech patterns are considered to generate high-quality text conversion results. Thereafter, the processor (130) applies natural language processing (NLP) techniques to the converted text to analyze detailed information. For example, the processor (130) may identify the subject of the text (e.g., schedule management, notification setting, inquiries, etc.), recognize the user's intended command or request, and extract key information such as date, time, location, and names. Additionally, the processor (130) may determine the emotional state embedded in the text. Then, based on the analyzed detailed information, the processor (130) classifies the text data. Classification criteria may include command types, chronological sorting, user priority, and more. Subsequently, the processor (130) stores the classified text data in a database (DB). The storage structure may be designed hierarchically to facilitate efficient retrieval and utilization of the data.

Thereafter, the processor (130) inputs the classified text into at least one generative agent according to its purpose, and the agent processes the user's personalized data to generate content corresponding to the purpose. To achieve this, when a query is input by the user, the processor (130) analyzes the input query and selects an agent to which the query is to be delivered based on the analysis result. Upon receiving the query input by the user, the processor (130) first analyzes the query to understand its content and intent. In this process, the processor (130) utilizes natural language processing (NLP) techniques to analyze keywords, context, and grammatical structure of the input query, and thereby identifies the user's intent. Based on the analyzed query information, the processor (130) selects a suitable agent according to predefined agent classification criteria. For example, if the user's query is for searching specific information, it is delivered to an information search agent; if the query is related to schedule management, it is delivered to a schedule management agent. If the user's query is related to resume or cover letter generation, it is delivered to a resume generation agent. Such agent selection can be based on the query’s category, the priority of keywords, and the function and role of each agent.

In addition, the processor (130) may convert the query data into a format suitable for processing by the selected agent, if necessary, before delivering the query to the agent. The conversion process is performed in consideration of the agent's input format requirements and processing logic. The processor (130) also refers to the user’s personalized data (e.g., user profile, past query history) to reflect it in the agent selection process, allowing the generation of customized results even for identical queries. In the embodiment, by effectively analyzing the user’s query and selecting an appropriate agent based on the analysis result, the processor (130) provides the advantage of handling various user needs quickly and accurately. This not only enhances the user experience but also improves the processing efficiency of the system.

In the embodiment, the processor (130) compares the requested function of the input query with the execution functions of each agent and selects an agent that performs a function similar to the requested one above a certain threshold. To achieve this, the processor (130), which has received the query input by the user, analyzes the grammatical structure, keywords, and intent of the query using natural language processing (NLP) techniques. Through this process, the requested function of the query is clearly defined. For example, the query “Write a cover letter for Company A” is interpreted as the requested function “cover letter generation.” In the embodiment, the processor (130) refers to a database that defines the executable functions and roles of all agents in the system. The executable functions of each agent are structured by function keywords, role scope, processing priority, etc., and are stored in a format comparable to the query's requested function.

Subsequently, the processor (130) compares the similarity between the requested function and the execution functions of each agent. In this process, the processor (130) calculates a similarity score between the requested function and each agent's execution function using text similarity comparison algorithms (e.g., cosine similarity, Jaccard similarity) and machine learning models (e.g., text classification models). For example, the request “Write a cover letter” may show a high level of similarity with the function of the “cover letter generation agent.”

In the embodiment, the processor (130) selects as candidates those agents whose calculated similarity scores exceed a predefined threshold (e.g., 80%). If multiple agents are included in the candidate group, the agent with the highest similarity score is preferentially selected. If multiple agents have similar similarity scores, the processor (130) may further consider the user’s past query history and preference data to determine the optimal agent.

Thereafter, the processor (130) transmits the query to the selected agent and, if necessary, modifies or supplements the query to match the requested function. For example, if the query includes only the keyword “Company A first half cover letter,” the processor (130) may supplement it to “Company A cover letter” before transmission.

In the embodiment, by comparing the similarity between the requested function and the execution functions of agents, the system can select the most appropriate agent for the user's request, thereby improving the accuracy of query processing and enhancing the user experience. In addition, this allows for efficient query distribution even in an environment where various agents coexist.

In addition, the processor (130) may select at least two or more agents based on the result of the query analysis, and the selected agents may cooperate to generate a response content for the query. To this end, the processor (130) analyzes the input query to identify the functions requested by the query. In this process, the structure of the query is analyzed. In the embodiment, multiple requests within the query are separated. For example, a query such as “Generate a cover letter for Company A and provide competency information” is divided into two requests: “cover letter generation” and “request for competency information.” Thereafter, the processor (130) clearly defines each requested function and extracts keywords related to each request. The processor (130) then compares the analyzed requested functions with the execution functions of each agent and selects the agents suitable for processing each request. In the embodiment, the processor (130) calculates similarity scores for each requested function to identify suitable agents as candidates. In order to process multiple requested functions, a plurality of agents may be selected. For instance, “cover letter generation” may be handled by the “cover letter generation agent,” while “competency information request” may be handled by the “job analysis agent.” Subsequently, the processor (130) establishes cooperative relationships between the selected agents. To do this, the processor (130) clearly defines which part of the query each agent should process, and activates a communication protocol that enables sharing of necessary data and intermediate results between the agents. Furthermore, the processor (130) integrates the response data individually generated by each agent into final content. Then, the processor (130) generates content through cooperation of the selected agents. In the embodiment, each agent processes its assigned requested function and generates related data. For example, the “cover letter generation agent” returns cover letter information, and the “job analysis agent” returns competency information required for a specific company. The processor (130) then coordinates the results received from each agent and integrates them into a form optimized for the user’s request. Thereafter, it converts the integrated content into a final output format suitable for a user interface. In the embodiment, the final generated content is optimized based on the user’s personalized data (e.g., preferences, past records). For instance, if the user previously emphasized specific information in a similar query, the corresponding information may be provided in greater detail.

In addition, the processor (130) may train a cooperation mechanism between at least two agents for each type of generated content based on the analysis result of the input query via an artificial intelligence model, and fine-tune the cooperation mechanism based on evaluation information indicating whether the generated content corresponds to its intended purpose. To this end, the processor (130) receives a query (e.g., text, voice, image) input by a user. The query is analyzed using an artificial intelligence model (e.g., a natural language processing model, vision model, etc.), and the analysis results may include intent analysis results, key entity extraction results, and contextual understanding results. For example, the intent analysis result refers to the determination of the user's objective to be achieved through the query; the key entity extraction result refers to the identification of important information (e.g., keywords, entities) in the query; and the contextual understanding result refers to the analysis of context considering the user’s prior interactions and the current situation. Thereafter, suitable content is generated according to the analyzed query. The type of content (e.g., document, image, voice) may vary depending on the intent and requirements of the query. In the embodiment, for efficient handling of the generated content, the processor (130) learns the cooperation mechanism among at least two agents. Subsequently, the roles performed by each agent are automatically assigned, and data exchange and task sequence among the agents are optimized. In addition, a conflict-avoidance and synchronization strategy between agents is also established.

Furthermore, in order to improve the performance of the cooperation mechanism, a reinforcement learning-based reward system may be employed.

In addition, the processor (130) may perform both objective and subjective evaluations to determine whether the content generated through cooperation between the agents meets the purpose of the input query. In an embodiment, the objective evaluation is automatically performed based on predefined goals and criteria (e.g., accuracy, completeness, validity), whereas the subjective evaluation is a process of assessing the quality of the generated content through user feedback. The processor (130) may also compare the generated content with content produced by other artificial intelligence models to evaluate its relative performance. Thereafter, the processor (130) fine-tunes the cooperation mechanism based on the evaluation information (quantitative scores and qualitative feedback).

In the embodiment, during the fine-tuning process, the processor (130) may adjust the task priorities and role assignment weights among the cooperating agents or remove inefficient cooperation steps. Additionally, the data exchange paths may be improved.

Furthermore, the processor (130) may perform model retraining (e.g., transfer learning, fine-tuning) using the evaluation results. The optimized cooperation mechanism is then stored along with the generated content and reused in similar use cases. Continuous learning and fine-tuning may also be performed in response to additional queries and new content generation requests.

Through this, the efficiency of cooperation among agents can be maximized, enabling the generation of content that precisely meets user requirements and the continuous provision of an improved cooperation mechanism. This makes it possible to implement an innovative system that simultaneously provides reliability and flexibility for diverse user needs.

In an embodiment, the processor (130) provides a system capable of effectively processing complex queries through a multi-agent cooperation method, allowing for the generation of accurate and integrated response content that satisfies user demands. This approach can efficiently handle complex requirements that are difficult for a single agent to process.

In addition, when the similarity between the requested function of the query and the execution function of the agent is below a certain threshold, the processor (130) evaluates the relevance between the query and the objective of the agents and selects a predetermined number of agents in the order of highest relevance. To this end, the processor (130) compares the requested function of the query input by the user with the execution functions of the agents and scores the similarity. If the similarity score is below a predefined threshold (e.g., 50%), it is determined that selecting an appropriate agent based solely on similarity is difficult. Thereafter, if the similarity is below the threshold, the processor (130) evaluates the relevance between the query and the agents through the following steps. In the embodiment, the main keywords, context, and intent of the requested function are segmented and extracted. For example, the query “Tell me the competencies and aptitudes required to join Company A” may be divided into keywords such as “Company A,” “competencies,” and “aptitudes.”

Thereafter, the objectives and roles of each agent are stored in a predefined database, and the relevance is evaluated by comparing the query’s keywords with the corresponding objectives. For example, the keyword “competency” may have high relevance with the “job aptitude analysis agent.” Subsequently, the processor (130) utilizes a text similarity algorithm (e.g., Word2Vec, BERT) or a domain-specific relevance matrix to score the relevance between the query and the objectives of each agent. This score reflects not only functional similarity but also conceptual similarity and alignment with the agent’s goal.

Thereafter, the processor (130) ranks the agents in order of highest relevance based on the calculated relevance scores and selects a predetermined number (e.g., top 3) of agents.

In an embodiment, the processor (130) ranks the scores and preferentially selects the top agents. Additionally, the embodiment applies an additional rule to ensure that the selected agents do not belong to the same functional group, thereby including agents from various functional groups. Thereafter, in the embodiment, the agents selected through relevance evaluation collaborate in subsequent procedures to generate a response to the user request. In the embodiment, each agent processes its own data related to the query and generates an intermediate result. For example, with respect to “competency,” the job analysis agent and the consultation agent may respectively return their results. Subsequently, the processor (130) integrates the results among the agents to generate a response optimized for the user request. The response is then converted into a format suitable for the user interface and delivered, and it may be continuously improved through user feedback. In the embodiment, the processor (130) collects user response data to continuously learn and improve the relevance evaluation algorithm between queries and agents. Through this, the accuracy of selecting appropriate agents can be gradually improved even in cases of low similarity.

In the embodiment, even when there is a low direct similarity between the requested function and the agent’s executable function, by evaluating relevance and selecting appropriate agents, the system may flexibly and accurately respond to complex or ambiguous user queries. This improves user experience and maximizes system processing efficiency.

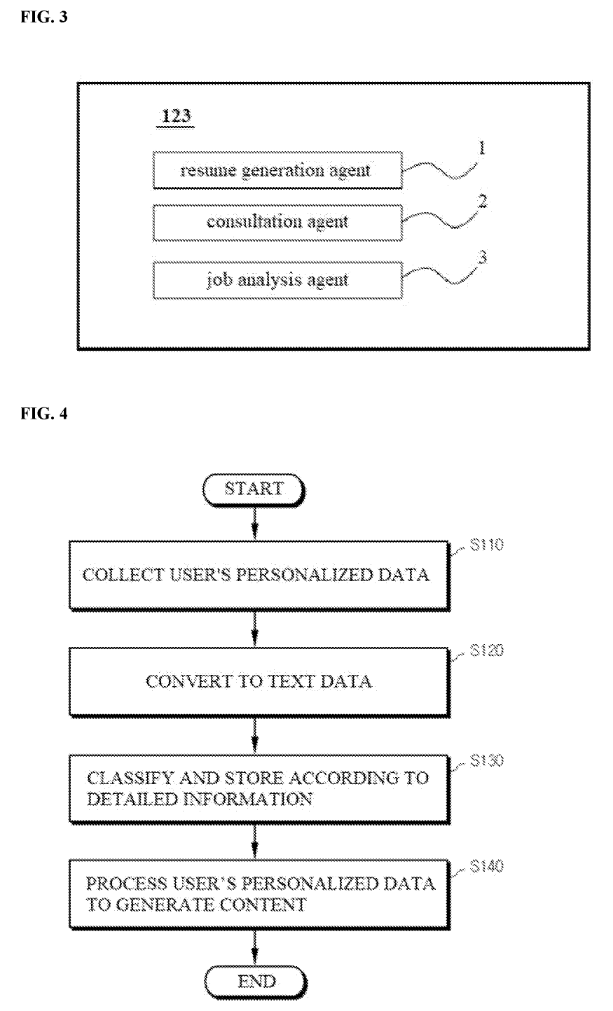

FIG. 3 is a diagram illustrating types of agents stored in the memory according to an embodiment.

Referring to FIG. 3, the agents according to the embodiment may include a resume generation agent (1), a consultation agent (2), and a job analysis agent (3).

In an embodiment, the resume generation agent (1) analyzes the text data converted from user's personalized data to extract the user's past experiences and career history, and generates a resume, cover letter, and application form using the extracted experiences and career information.

The user’s diaries, recorded audio data, and the like are converted into text using STT (Speech-to-Text) technology, and past experiences and career history are systematically analyzed. Through this, key information necessary for employment or application writing is automatically extracted. For example, if the diary contains an entry related to “volunteer experience,” the resume generation agent converts the content into a phrase that is advantageous for employment. Furthermore, the agent analyzes the user’s values (e.g., teamwork, leadership) and links them to the competencies required by companies. In this way, the resume agent can generate a resume that reflects the user’s desired tone (e.g., formal or informal) and the job application requirements of a specific company. Specifically, if creativity is emphasized by a particular company, the resume generation agent, according to the embodiment, extracts relevant experiences from the diary and generates customized phrases. Additionally, the resume generation agent may suggest directions for improvement of the generated resume or provide questions to supplement missing content. For example, it may generate feedback such as “It would be good to add leadership experience. Could you describe the role you played in a past team project?”

The counseling agent (2) analyzes text and conversation records among the user's personalized data to identify the user's emotional state and generates questions and messages to be presented to the user based on the identified emotional state. To this end, the counseling agent (2) performs emotion analysis based on personalized data. In the embodiment, the counseling agent (2) analyzes user-written text and conversation records to determine the current emotional state (e.g., stress, happiness, anxiety). Through this analysis, appropriate questions or messages are generated in real time. For example, the counseling agent (2) may generate an output such as, “There are many records in recent diary entries expressing stress. Would you like some support to help you calm down?” Subsequently, the counseling agent (2) provides dialogues and messages suitable for the emotional state. The counseling agent (2) suggests conversations tailored to the user's emotions and provides encouraging messages or positive feedback. Specifically, the counseling agent (2) may generate and output a message such as, “It seems you might be feeling overwhelmed. How about reflecting on a time in the past when you successfully overcame a similar situation?”

The counseling agent (2) may also recommend psychological support resources (e.g., mental health counseling apps, meditation guides) as needed, and support the user in achieving immediate emotional stability through conversation, while continuously monitoring emotional changes through ongoing dialogue.

The job analysis agent (3) analyzes the user's career, skills, and interests to suggest competencies suitable for specific job roles and provide directions for development. To this end, the job analysis agent (3) identifies the user's job aptitude information by analyzing user's personalized data that has been converted into text and, based on the identified job aptitude information, suggests the competencies the user should develop and methods for developing them. In the embodiment, job aptitude information includes the user's career, skills, and interests.

In the embodiment, the job analysis agent (3) collects basic data provided by the user (e.g., academic background, work experience, skill level, personality assessment). Additionally, it may collect the user's activity data (e.g., project participation records, performance reviews) and behavioral data (e.g., problem-solving approaches, interpersonal style). The collected data is then converted into text or structured and preprocessed into a form suitable for processing by natural language processing (NLP) and analysis models. For example, the statement “Three years of experience as a programmer proficient in Python” may be preprocessed as “Python programmer, 3 years of experience.” Thereafter, the job analysis agent (3) analyzes the text-based job aptitude information. In the embodiment, the agent evaluates the user's job aptitude by analyzing the preprocessed text data. To do this, the agent extracts key keywords from the input data and maps them to a job requirement database to analyze suitability. For example, “Python, data analysis” may be analyzed as having high suitability for a data scientist position. In addition, based on the text data, the agent analyzes the user’s competencies and compares them with a competency matrix required for each job to identify any deficiencies. For instance, “low communication skills” may be analyzed as requiring further development for a project management position. Furthermore, the job analysis agent (3) utilizes an NLP model to analyze the context and meaning of the input data and calculate its relevance to specific jobs. Based on the analyzed data, the agent identifies the user's job aptitude information. The aptitude information may be provided as “Recommended jobs: Generates a list of job recommendations based on the user’s competencies, personality, and experience.” Additionally, the job analysis agent (3) may provide results such as “Suitability for data analysis/machine learning expert: 85%.” Subsequently, the most suitable jobs for the user are sorted in order of priority, and for each suitable job, the lacking competencies and areas for development are specified.

In addition, the job analysis agent (3) derives the areas in which the user lacks competencies necessary for job performance based on the analysis results. For example, such deficiencies may be derived as “lack of leadership skills” or “insufficient proficiency in data visualization tools.” Subsequently, the agent suggests online/offline training courses or certification programs related to the lacking competencies. For example, a competency development course may be recommended as “Recommended training program XXX for leadership development.” Furthermore, mentoring programs or expert coaching sessions related to specific jobs may also be recommended. In the embodiment, the job analysis agent (3) may provide the results in the form of a customized report to facilitate user understanding. The report may include the recommended jobs and aptitude scores, a list of lacking competencies, detailed methods for competency development, and suggested development plans by time and stage.

For example, the job analysis agent (3) may return content such as “Based on your current data analysis experience, a transition to the field of data science is recommended. Additionally, learning machine learning technologies would be advantageous for the career change.”

In addition, in the embodiment, each agent generates various personalized content according to the user's requirements. For example, the travel planning agent may return an output such as “To relieve your recent stress, we recommend a travel destination. Consider visiting a nearby nature retreat over the weekend.”

Moreover, in the embodiment, all agents share a central database to maintain consistency and efficiency of data. For instance, data regarding emotional states identified by the counseling agent may be utilized by the cover letter generation agent. In the embodiment, multiple agents collaborate within a single platform to meet diverse user needs, thereby continuously updating user data and enabling the generated results to evolve accordingly. Additionally, content optimized for specific purposes is generated to provide a personalized experience.

Hereinafter, FIG. 4 will be described. The content generation method using purpose-specific multi-agents based on user's personalized data shown in FIG. 4 may be performed by the content generation apparatus (100) using purpose-specific multi-agents based on user's personalized data, which includes the processor (130).

Meanwhile, FIG. 4 is merely illustrative, and the spirit of the present invention should not be interpreted as being limited to what is depicted in FIG. 4. For example, the respective steps may be arranged in an order different from that shown in FIG. 4, at least one of the steps depicted in FIG. 4 may not be performed, or one or more additional steps not depicted in FIG. 4 may be performed.

Hereinafter, a content generation method using purpose-specific multi-agents based on user's personalized data will be described sequentially. Since the operation (function) of the method according to the embodiment is essentially the same as the function of the system, repeated descriptions of FIGS. 1 to 3 will be omitted.

FIG. 4 is a diagram illustrating the content generation process using purpose-specific multi-agents based on user's personalized data according to an embodiment.

Referring to FIG. 4, in step S110, the user's personalized data is collected, and in step S120, the collected personalized data is converted into text using speech-to-text (STT) technology. In step S130, the converted text is classified and stored according to the detailed information of the text. Thereafter, in step S140, the classified text is input into at least one generative agent, and the agent processes the user's personalized data to generate content.

The content generation method and apparatus using purpose-specific multi-agents based on user's personalized data a according to the embodiment can maximize user experience by generating content tailored to the user's characteristics and goals based on user's personalized data.

In addition, in the embodiment, efficiency and user satisfaction are enhanced by providing optimized outputs tailored to individual needs, such as resume generation, counseling, and job analysis.

Furthermore, through the embodiment, multiple agents can collaborate to perform various purposes, allowing multiple issues to be addressed within a single platform. For example, during resume writing, the system can also analyze the user's emotional state and provide counseling messages to alleviate stress.

In the embodiment, by sharing a central database and managing data in an integrated manner, redundant tasks can be reduced, and data consistency can be maintained. For example, the analysis results of the counseling agent can be utilized in resume writing to generate contextually natural content.

Additionally, the embodiment reduces the time and effort required for users to manually analyze information or create content, by automatically analyzing diary entries and converting them into appropriate expressions that can be immediately used.

Moreover, the embodiment can generate content optimized for the user's goals (e.g., job search, counseling, career development), thereby producing concrete outcomes. For example, by creating resumes tailored to the requirements of specific companies, the system can help improve the user’s chances of successful employment.

In addition, the embodiment provides users with immediate feedback and support through real-time response functions such as emotion analysis. For example, when a stress state is detected, a message that offers psychological relief can be delivered immediately. Moreover, as more data accumulates through the embodiment, the precision of the AI service is enhanced, and the user’s sense of personalization and satisfaction continues to increase. Over time, this allows for the provision of content that better matches the user's preferences and goals.

Additionally, in the embodiment, the counseling agent monitors the user’s emotional state and provides immediate assistance when needed, thereby contributing to mental stability. Based on the platform’s flexibility and multifunctionality, it can be applied in various fields such as education, employment, psychological counseling, and travel planning. Through efficient and personalized services, the platform helps users achieve their goals more easily.

Meanwhile, the methods according to various embodiments of the present invention described above may be implemented in the form of an application or software program installable on conventional electronic devices.

Moreover, all or part of the method may be composed of multiple software function modules and implemented on an operating system (OS). Each step may be configured as a single software function module, or a combination of steps may be integrated into a single software function module implemented on the operating system. Therefore, even if not all embodiments of the present disclosure are implemented as a single software function module, if multiple software function modules implement the respective steps of the present disclosure and are executed within a single OS, it can be understood as implementing the method of the present disclosure.

Furthermore, the methods according to various embodiments of the present invention described above may be implemented through a software upgrade or hardware upgrade of an existing electronic device. Additionally, the various embodiments of the present invention may be executed through an embedded server included in an electronic device or an external server of the electronic device.

Meanwhile, according to an embodiment of the present invention, the various embodiments described above may be implemented as software including instructions stored in a computer-readable recording medium using software, hardware, or a combination thereof, which can be read by a computer or a similar device. In some cases, the embodiments described in this specification may be implemented directly in a processor. In a software-based implementation, the procedures and functions described herein may be implemented as separate software modules. Each software module may perform one or more functions and operations described in this specification.

Meanwhile, a computer or a similar device may refer to a device that retrieves instructions stored in a storage medium and operates according to the retrieved instructions, and may include a device according to the disclosed embodiments. When the instructions are executed by a processor, the processor may perform the corresponding functions either directly or by utilizing other components under its control. The instructions may include code generated or executed by a compiler or interpreter.

The computer-readable recording medium may be provided in the form of a non-transitory computer-readable recording medium. Here, the term "non-transitory" means that the storage medium does not include a signal and is tangible, and it does not distinguish whether the data is stored permanently or temporarily on the storage medium. In this context, a non-transitory computer-readable medium refers to a medium that stores data semi-permanently and is readable by a device, rather than media such as registers, caches, or memory that store data for a brief moment. Specific examples of non-transitory computer-readable media include CD, DVD, hard disk, Blu-ray disc, USB, memory card, ROM, and the like.

As described above, exemplary embodiments have been disclosed in the drawings and the specification. Although specific terms have been used to describe the embodiments in this specification, such usage is solely for the purpose of explaining the technical spirit of the present disclosure and is not intended to limit the meaning or the scope of the claims. Therefore, those skilled in the art will understand that various modifications and equivalent alternative embodiments are possible based on this disclosure. Accordingly, the true technical protection scope of the present disclosure should be defined by the technical spirit of the appended claims.

What is claimed is:

1. A generation apparatus comprising:
a memory configured to store at least one instruction for generating contents using purpose-specific multi-agents based on user's personalized data; and
a processor configured to execute the instruction,
wherein the processor is configured to:
collect personalized data including a user’s voice;
convert the collected personalized data into text using speech-to-text (STT);
classify and store the converted text according to detailed information of the text; and
input the classified text into at least one generative agent categorized by purpose, wherein the generative agent processes the user's personalized data and generates content corresponding to the purpose.

2. The generation apparatus of claim 1, wherein the processor is configured to analyze a query when the query is input by the user and select at least one generative agent to which the query is to be delivered based on a query analysis result.

3. The generation apparatus of claim 2, wherein the processor is configured to compare a requested function from the input query with functions performed by respective generative agents and to select at least one generative agent that performs a function similar to the requested function above a predetermined threshold level.

4. The generation apparatus of claim 2, wherein the processor is configured to select at least two generative agents based on the query analysis result, and the selected generative agents cooperate to generate content corresponding to a purpose of the query.

5. The generation apparatus of claim 4, wherein the processor is configured to evaluate relevance between the purpose of the query and a goal of each generative agent, and select a certain number of generative agents in order of highest relevance, when similarity between a requested function of the query and the functions performed by the generative agents is below a predetermined threshold level.

6. The generation apparatus of claim 4, wherein the processor is configured to learn a cooperation mechanism among the at least two generative agents for each generated content based on the query analysis result using an artificial intelligence model, and fine-tune the cooperation mechanism based on evaluation information indicating whether the generated content corresponds to the purpose of the query.

7. The generation apparatus of claim 1, wherein the generative agent comprises at least one of a resume generation agent, a counseling agent, and a job analysis agent.

8. The generation apparatus of claim 7, wherein the resume generation agent analyzes text data converted from the user's personalized data to extract the user’s past experiences and career history, and generates a resume, cover letter, and application form using the extracted experiences and career history.

9. The generation apparatus of claim 7, wherein the counseling agent analyzes text and conversation records from the user's personalized data to determine the user’s emotional state and generates questions and messages to be presented to the user based on the determined emotional state.

10. The generation apparatus of claim 7, wherein the job analysis agent analyzes text data converted from the user's personalized data to identify the user's job aptitude information, and proposes capabilities that the user needs to develop and methods for developing the capabilities based on the identified job aptitude information.
